(19) United States
(12) Patent Application Publication
(10) Pub. No.: US 2014/0287157 A1
(43) Pub. Date: Sep. 25, 2014

(54) METHOD OF MANUFACTURING A MAGNETIC RECORDING MEDIUM

(71) Applicants: Boris A. Gurovich, Moscow (RU); Evgenia A. Kuleshova, Moscow (RU); Kirill E. Prikhodko, Moscow (RU)

(72) Inventors: Boris A. Gurovich, Moscow (RU); Evgenia A. Kuleshova, Moscow (RU); Kirill E. Prikhodko, Moscow (RU)

(21) Appl. No.: 14/222,618

(22) Filed: Mar. 22, 2014

(30) Foreign Application Priority Data
Mar. 22, 2013 (RU) 2013112754

(51) Int. Cl. G11B 5/85; G11B 5/851

(52) U.S. Cl. CPC G11B 5/85; G11B 5/851
USPC 427/552

(57) ABSTRACT

In the proposed method of manufacturing a magnetic recording medium, the first layer of the original material, is placed onto the substrate. A second layer of the second material is placed on the first layer. The thickness of the second layer is 3.8 nm or more. A lithographic mask with cavities according to the specified topology is placed on the second layer. The changes in the magnetic characteristics of the original material on the irradiated areas occur and provide for a plurality of magnetic elements. The magnetic characteristics of the original material in the areas protected by the lithographic mask are stored.

### FIELD OF INVENTION

The claimed invention relates to manufacturing methods of complex material by flows of accelerated particles, and more specifically, to a method of manufacturing a magnetic recording medium that can be used in nanotechnology and microelectronics for designing micro devices, integrated circuits, and memory devices.

### BACKGROUND OF THE INVENTION

The invention proposed herein is based on the well-known fact that has been described in, for example, Russian Patent No. 2129320, in which accelerated particle-induced selective atom removal of one of the elements that are part of the diatomic or polyatomic materials occurs, whereby the material having undergone irradiation changes its magnetic characteristics.

The method for manufacturing a magnetic recording medium described in this patent comprises the following steps: placing a first layer of nonmagnetic material which changes its magnetic characteristics induced by various accelerated particles on the nonmagnetic substrate, whereby 2 to 20 nm thick layer of the nonmagnetic material is placed on the substrate and the the layer of nonmagnetic material is selectively irradiated by a flow of accelerated particles, for example, using a lithographic mask placed on that layer. As a result, a set of magnetic (conductive) elements appear in the layer of nonmagnetic material. Protons, hydrogen atoms, ions, or helium atoms are used as accelerated particles, for example.

The use of this method requires divergence of the accelerated particles (e.g., the divergence angle should lie in the range from 0.1 to 3 degrees). The divergence of the accelerated particles is required to obtain elements of small (approximately 1 to 10 nm) lateral dimensions (dimensions in the plane of the first layer). Furthermore, the use of this method eliminates the possibility of obtaining magnetic elements in the small sizes in the material the thickness of which exceeds 20 nm. This can be explained by the fact that interaction of accelerated particles with the material makes these particles scatter. The scattering effect leads to the fact that the size of the range of the accelerated particles on the irradiated material is always larger than the flow of the accelerated particles or the size of the cavities in the mask, if the irradiation is performed through the mask. The greater the energy of the accelerated particles, the greater this excess is, and when the thickness of the first layer of the irradiated material is less than the length of the projected range of the accelerated particles in the material, the aforementioned excess is proportional to the thickness of the layer of the irradiated material.

Low-accelerated particles (from 0.05 to 1 keV), medium-accelerated particles (from 1 to 5 keV), and high-accelerated particles (from 5 to 100 keV) have pear-shaped scattering. The material which changes its magnetic characteristics under irradiation has a similar shape.

At low-accelerated particles, an increase in the lateral dimensions of the magnetic elements obtained is proportional to the length of the projected range of these particles, while when the thickness of the first layer is less than the length of the projected range of the accelerated particles, an increase in the lateral dimensions of the magnetic elements is proportional to the thickness of the first layer. Therefore, if the layer of the original irradiated material has the thickness specified in the method described herein (2 to 20 nm), the magnetic elements of small lateral sizes can be obtained. If the layer of the original material has the thickness of more than 20 nm, then ceteris paribus (type and energy of accelerated particles and radiation dose), the size of the magnetic elements of the conductive structure will also be larger. As a result, the use of this method for the manufacturing magnetic elements of small lateral sizes is possible for only a very thin layer of irradiated material. Moreover, manufacturing of a magnetic medium with a high density (more than 600 Gbit/inch²) requires manufacturing of the magnetic elements at a distance of less than 15 nm from one another which is impossible to carry out if the thickness of the first layer is greater than 20 nm.

In this regard, the placing of the lithographic mask on the layer of the original material may cause mechanical stress in that material, which is generated by the impact of various accelerated particles on the lithographic mask and leads to a change in magnetic characteristics of the original material not only in the areas located under the cavities of the mask, but also the partial or total change of magnetic characteristics of the original material in the areas protected by the lithographic mask, including areas located in a close proximity of the areas that are located under the mask cavities.

When the thickness of the layer of the original material is less than 20 nm and when it is necessary to obtain magnetic elements of high density and of small lateral dimensions in the process of irradiation, mechanical stress captures the entire thickness of the original layer, which leads to changes in magnetic characteristics of the original material in the areas protected by the lithographic mask.

As a result, the lithographic mask stops performing its protective function, leading to changes in the magnetic characteristics of the original material of the entire original layer. This problem limits the minimum lateral dimensions and maximum density the magnetic elements obtained. As a result, the lateral dimensions of each of the plurality of magnetic elements obtained in the original material increases. And this, in its turn, reduces possible density of magnetic elements, i.e., reduces the storage density on a magnetic recording medium that has been manufactured.

U.S. Pat. No. 6,565,929 describes a method for manufacturing a magnetic carrier which includes the following steps: placing a first layer of nonmagnetic material which changes its magnetic characteristics induced by various accelerated particles on the nonmagnetic substrate; using the material with low or zero initial magnetization as the material for the first layer; selective irradiation of the first layer of the material by a flow of accelerated particles using, for example, a lithographic mask placed on this layer in order to change the magnetic characteristics of the material of the layer and to obtain the aggregate of magnetic elements, each of which has first, second, and third total size; wherein the ratio of the first maximum overall size to the second and third overall sizes ranges (3.5-15):1; the formation of the first layer with thickness equal to the first, second, or third overall size of any magnetic segment out of the magnetic segments.

The use of this method results in low density of magnetic elements obtained, i.e. a low storage density of a magnetic recording medium that has been manufactured. This is because the obtained magnetic elements are arranged in plane of the first layer, rather than in the perpendicular direction to this layer, which could have ensured high storage density (600 Gbit/inch²). In addition, the relatively low anisotropy (ratio of larger size to a smaller size in plane of the first layer) of the specified magnetic elements reduces the storage reliability of the recorded information from the possibility of spontaneous reversal magnetization of the magnetic areas caused by improper storage or use of magnetic media, such as the magnetization reversal process or impact heat.

To ensure storage stability when using this method, each magnetic element has to be of a large size. This will increase the size of each of the plurality of the magnetic elements obtained in the original material and limit possible density of the magnetic elements that have been obtained (less than 600 Gbit/inch²).

U.S. Pat. No. 5,820,769 describes a method for manufacturing a magnetic medium which includes a nonmagnetic substrate. A plurality of discrete single magnetic domain elements formed of a magnetic material separated by nonmagnetic materials is carried on the nonmagnetic substrate. Each single magnetic domain element has the same size, shape and has, without an external magnetic field, two quantized magnetization values. The two magnetization values are of substantially equal magnitude but of differing vector directions.

The aforementioned method includes the following steps. On the nonmagnetic substrate, a protective mask is formed of the resist with a thickness of 130 to 720 nm. Polymethyl methacrylate is used as the resist. An electron beam is focused on the resist to form a spot having a diameter of about 4 nm. Then etching is performed as a result of which cavities unprotected by the resist are formed on the nonmagnetic substrate. Magnetic material is then applied onto the the cavities by deposition and sputtering. Then the resist is removed, and the space formed between the magnetic materials is filled with nonmagnetic material.

This method produces magnetic elements of a relatively large size that have a length of approximately 120 nm and a diameter of 35-40 nm. That is, the anisotropy shape of the magnetic elements is characterized by a length to diameter ratio in the range of 3-3.4, while the distance between the magnetic elements is from 50 to 1000 nm. As a result, the storage density on a magnetic medium that is manufactured (i.e., density of obtained magnetic elements) is low (less than 600 Gbit/inch2). Thus, a relatively weak anisotropy of the form of the magnetic storage elements reduces the storage reliability of the recorded information due to the possibility of spontaneous magnetization reversal of magnetic areas caused by improper storage conditions of the magnetic media, such as heat.

Russian Patent No. 2404479 describes a method for manufacturing a magnetic recording medium which comprises the following steps: placing a layer of nonmagnetic original material which changes its magnetic characteristics induced by various accelerated particles on the nonmagnetic substrate; the use of metal oxide or oxide alloy (e.g., cobalt oxide, cobalt platinum alloy) as the original material; placing a lithographic mask that has cavities according to specified topology on the layer of the original material; irradiating the original material through the cavities in the lithographic mask by a flow of accelerated particles in order to change the magnetic characteristics of the original material on the irradiated sites to obtain the aggregate of magnetic elements; applying oxygen ions on the magnetic elements that have been obtained; creating the cavities in the lithographic mask with an aspect ratio (ratio of thickness of the lithographic mask to the minimum cavity size in the mask), which would manufacture the magnetic elements that have a minimum transverse dimension which is smaller than the minimum transverse size of the cavities in this mask.

In this method, in order to reduce the lateral dimensions of the magnetic elements obtained, the combined magnetic elements obtained after partial restoration of the original material of the first layer by irradiation with protons are irradiated by a flow of oxygen ions. This results in oxidation of the partially reduced oxide of the original material and provides for manufacturing of the magnetic elements that have minimal lateral dimensions which are less than the minimum lateral dimensions of the cavities in the mask.

However, this approach requires an incomplete reduction of the original material, placed under the cavities of the lithographic mask, and this limits a possible dose of the proton radiation. As a consequence, the resulting aggregate of the magnetic elements has a low magnetic moment (i.e., low magnetic properties), making it difficult to read information from the magnetic elements that have been manufactured and to use these elements as storage elements.

Moreover, in order to manufacture magnetic elements of small lateral dimensions with high magnetic properties, full restoration of the original material of the first layer on the irradiated areas under the cavities of the lithographic mask is required, that is, the use of significant doses (from 10¹⁸ to 10¹⁹ particle/cm²) of proton irradiation. This leads to the scattering of protons in the irradiation process and as a consequence, an increase in the lateral dimensions of the magnetic elements, which in its turn leads to overlapping and merging of adjacent magnetic elements.

To reduce the lateral dimensions, it is required to reduce thickness of the first layer, for example, to 1-5 nm. However, the decrease in thickness of the first layer leads to insufficient amount of the magnetic material obtained in the magnetic elements, that is, a decrease in the magnetic moment of each of the plurality of magnetic elements obtained.

Additionally, placing the lithographic mask over the layer of original material creates mechanical stress in the material which is formed by the impact of the accelerated particles on the lithographic mask and causes a change in magnetic characteristics of the original material not only on the areas located under the cavities of the lithographic masks, but also to the partial or complete change of magnetic characteristics of the starting material on the areas protected by the mask, including areas located in a close proximity to the areas placed under the cavities of the mask.

As a result, lateral dimensions of each of the plurality of the magnetic elements obtained in the source material increases. There also may be merging of magnetic elements, which occurs due to changes in the magnetic characteristics of the material disposed in the gaps between the magnetic elements that have been obtained. This in turn reduces the possible density of the magnetic elements, that is, reduces the number of magnetic elements produced per unit area of the first layer of the original material.

### SUMMARY OF THE INVENTION

The main object of the present invention is to reduce the lateral dimensions of each of the plurality of the magnetic elements obtained in the original layer of the source material.

Another, no less important object of the present invention, is to increase the density of the magnetic elements, that is, increase the number of magnetic elements per unit area of the original layer of the source material.

Another object of the present invention is to increase the magnetic moment of each of the plurality of magnetic elements obtained by implementing the full recovery of the first layer of material on the portions placed under the cavities of the lithographic mask.

Another object of the present invention is to eliminate the changes in the magnetic characteristics of the original material in the immediate proximity of the areas placed under the cavities of the lithographic mask, i.e., eliminate fusion of magnetic elements that have been obtained.

These and other objects of the present invention have been achieved by designing a method for manufacturing a magnetic medium which includes the following steps:
placing the first layer of the original material which changes its magnetic characteristics due to various accelerated particles on the substrate;
using the lithographic mask that has cavities according to specified topology;
irradiating the layer of the original material through the cavities in the lithographic mask by a flow of the accelerated particles in order to modify the magnetic characteristics of the source material of the first layer;
   In this regard, according to the invention, the method suggested herein includes the following steps:
use of nonmagnetic chemical compound containing atoms of at least one magnetic element and atoms of at least one element which is a gas under normal conditions as the original material for modifying the magnetic characteristics of the original material;
placing a second layer of the second material that maintains its magnetic properties under the influence of various accelerated particles on the first layer of the original material;
the second layer of the second material is placed with thickness of 3.8 nm or more;
using a material which has minimal parameter of the crystal lattice that differs by 15% or less from the minimal parameter of the crystal lattice of the original material of the first layer, as the second material of the second layer;
placing the lithographic mask on the second layer of the second material;
the irradiating of the first layer of the original material by a flow of the accelerated particles through the cavities of the lithographic mask in order to change the magnetic characteristics of the original material and to obtain the aggregate of magnetic elements on the irradiated areas and to preserve the magnetic characteristics of the original material of the first layer in areas protected by the lithographic mask;
the irradiating of the first layer of the original material by a flow of the accelerated particles that is carried out with energy sufficient for the selective removal of atoms of at least one element which is a gas under normal conditions from the original material of the first layer on the irradiated regions in order to obtain a specified set of magnetic elements.

The use of the second layer of the second material as a buffer between a first layer of the original material and the lithographic mask preserves the protective properties of the mask, that is, eliminates magnetic properties of the original material of the first layer in the areas protected by the lithographic mask.

In this, the use of the second material which retains its magnetic properties induced by various accelerated particles and has minimal parameter of the crystal lattice that differs by 15% or less from minimal parameter of the crystal lattice of the original material eliminates the mechanical stress that occurs in the original material when the lithographic mask is placed directly thereon (without the second layer of the second material) and is affected by a flow of accelerated particles. The use of the second material eliminates changes in the magnetic characteristics of the original material in the areas protected by the lithographic mask, including the areas located in a close proximity to the areas placed under the cavities of the lithographic mask. With this, the fusion of magnetic elements obtained by eliminating the magnetic characteristics of the material placed in the gaps between the obtained magnetic elements is also prevented.

This elimination of mechanical stress ensures high efficiency of the lithographic mask, reduction in the lateral dimensions of each of the plurality of the magnetic elements obtained in the material of first layer, and an increase in density of the magnetic elements and in the magnetic moment of each of the plurality of magnetic elements that have been obtained.

This ensures an accurate transfer of lithographic mask's cavity shape to the magnetic elements received in the first layer of the original material and preserves the nonmagnetic characteristics in the first layer of the original material in the gaps between the magnetic elements that have been obtained. With this, the shape of these gaps corresponds exactly to the closed areas of the lithographic mask. The thickness of the second layer of the second material provides a high efficiency of mechanical stress relief.

The irradiation of the first layer of the original material by a flow of accelerated particles that have energy sufficient to selectively remove atoms of gaseous elements from the material of the first layer provides a change of the magnetic characteristics of the material of the first layer on the irradiated areas and manufactures a magnetic medium that contains a set of magnetic elements that alternate with nonmagnetic elements.

It is advisable to carry on the irradiation of the first layer of the original material through the areas of the second layer of the second material, arranged under the cavities of the lithographic mask.

It is possible in the areas of the second layer of the second material arranged under the specified cavities of the lithographic mask to remove the second material and carry out the irradiation of the first layer of the original material on its areas located directly below the cavities of the lithographic mask.

It is advisable to place the second layer of the second material with a thickness of 5 to 10 nm.

It is also advisable to use oxide or nitride of a magnetic material as the nonmagnetic chemical compounds containing atoms of at least one magnetic element and atoms of at least one element which is a gas under normal conditions.

It is useful to use an oxide or nitride of a metal or alloy as the oxide or nitride of a magnetic material.

It is preferable to use cobalt oxide or nitride or an alloy of cobalt and platinum as the oxide or nitride of the metal or alloy.

It is advisable to use an oxide or a nitride of a nonmagnetic material as the second material.

It is possible to use a silicon nitride (Si₃N₄) as the nitride of a nonmagnetic material.

It is desirable to use protons or hydrogen atoms as the accelerated particles.

Thus the use of the proposed method allows reducing the lateral dimensions of each of the plurality of the magnetic elements obtained in the original material in the first layer.

Furthermore, the use of the proposed method allows increasing the density of the magnetic elements, i.e., the number of magnetic elements per unit area of the first layer of the original material.

Moreover, the use of the proposed method allows increasing the magnetic moment of each of the plurality of the magnetic elements obtained in the original material in the first layer.

The use of the proposed method allows to eliminate the changes of magnetic characteristics of the original material in the areas protected by the lithographic mask, including the areas located in a close proximity of the areas placed under the cavities of the lithographic mask, i.e. avoids fusion of the magnetic elements that have been obtained, which occurs due to changes in magnetic characteristics of the material located in the gaps between the magnetic elements that have been obtained.

### BRIEF DESCRIPTION OF THE DRAWINGS

For a better understanding of the present invention, the following are specific examples of its embodiments with reference to the accompanying drawings, in which:

FIG. 1 illustrates the sequence of forming a magnetic medium using the second (intermediate) layer, i.e., forming patterned magnetic structure in a nonmagnetic matrix, one embodiment; and

FIG. 2 illustrates the sequence forming a magnetic medium using the second (intermediate) layer, i.e., forming patterned magnetic structure in a nonmagnetic matrix, another embodiment.

### DETAILED DESCRIPTION OF THE INVENTION

Several methods for manufacturing a magnetic recording medium using a lithographic mask that has cavities according to specified topology (a predetermined pattern) have been described in the introduction of the patent description.

It is also widely known that the lower the thickness of the lithographic mask, the smaller lateral dimensions of the magnetic elements of the magnetic medium that may be manufactured and the higher density may be achieved. Therefore, in microelectronics the tendency is to use lithographic masks that are as thin as possible.

However, studies conducted by the present inventors have shown that in some cases, the lithographic mask is insufficient for the irradiation of a layer of the original nonmagnetic material through a lithographic mask by a flow of accelerated particles in order to change the magnetic characteristics of the original material of the first layer on the irradiated areas in order to obtain the aggregate of magnetic elements. Namely, the lithographic mask has no protective effect even with its thickness, which, according to calculations (energy and dosage), would have been sufficient to prevent the impact of the accelerated particles on the areas of the original material protected by the lithographic mask, i.e., to prevent the selective removal of atoms of gaseous elements in the layer of the original material on the areas of this layer protected by the mask. It was found that when the layer of original nonmagnetic material is irradiated through the lithographic mask, the entire layer of the original material arranged under the mask is subjected to conversion.

In order to eliminate this phenomenon, studies have been conducted based on increasing the thickness of lithographic masks three or more times. However, the protective action of the lithographic mask, i.e., prevention of the selective removal of the atoms of gaseous elements (e.g., oxygen or nitrogen) on the areas of the original material of the first layer protected by this mask was not observed.

The inventors of the present invention suggested that the reason for this is the presence of mechanical stresses occurring in the first layer of the original material with the lithographic mask placed on it as a result of accelerated particles impacting the mask. The inventors suggested that this is due to the large difference in the parameters of the crystal lattice of the original material and the material of the lithographic mask.

The effect of mechanical stress in the original material resulting from its contact with the second material that has a substantially different parameter of the crystal lattice than the first material is well known from the production of semiconductor devices.

In order to eliminate the occurrence of the mechanical stresses, the inventors have suggested using on the first layer of the original material an intermediate layer of the material the parameters of the crystal lattice of which differ slightly from the parameters of the crystal lattice of the original material of the first layer.

The experiments have shown that when using this method, the selective removal of atoms of at least one element which is a gas, such as oxygen, nitrogen, or hydrogen, under normal conditions, on the protected areas of the first layer of the original material by the lithographic mask ceased even when using the lithographic mask with a thickness of 2 to 20 nm.

The inventors believe this is due to the fact that the second layer that is characterized by crystal lattice parameters that are slightly different from the parameters of the crystal lattice of the material of the first layer fully compensates the stresses generated by the lithographic mask and prevents undesirable and at least partial restoration of the original material of the first layer protected by this mask.

The method for manufacturing a magnetic medium described in the present invention is based on the effect described above and comprises a regular structure that contains parts for the storage of the magnetic material, isolated from one another by the parts of nonmagnetic material placed on the nonmagnetic substrate.

The described method is carried out the following way.

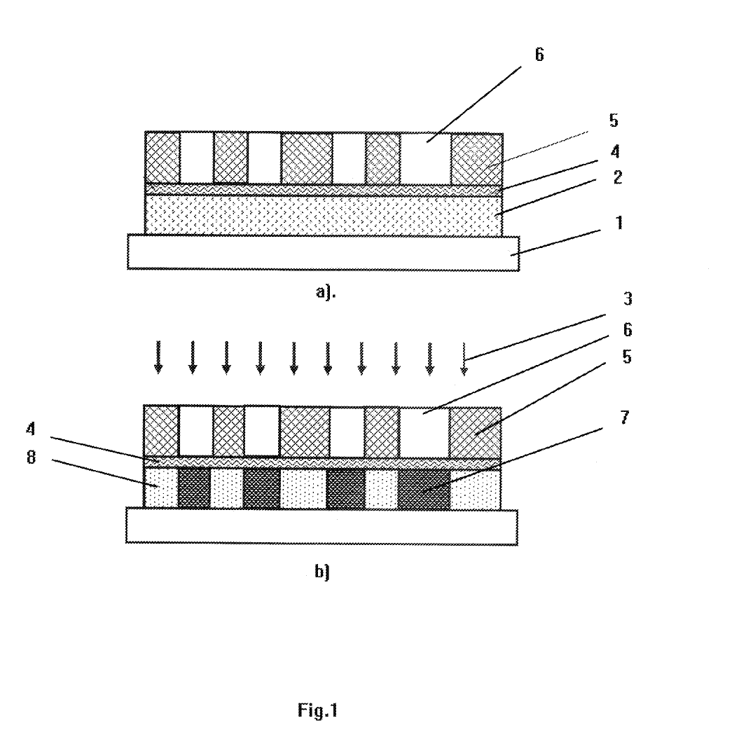

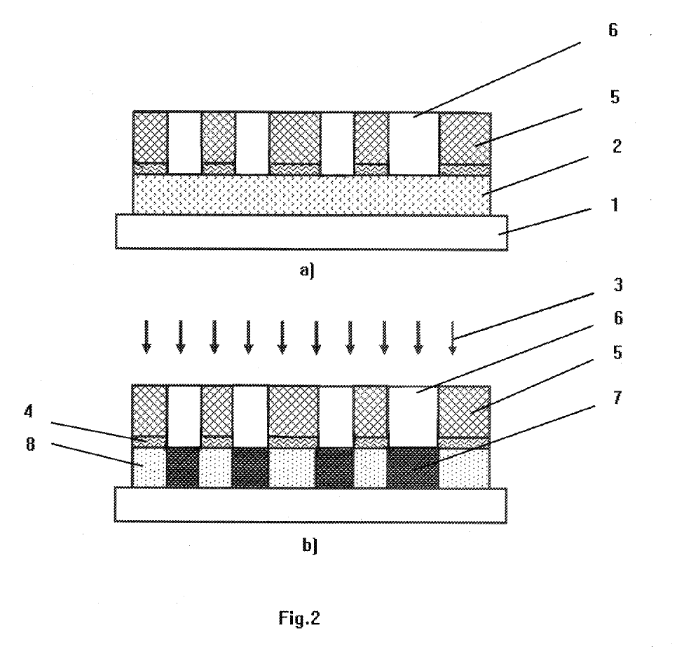

On the substrate (1) (FIGS. 1 and 2) made of, for example, aluminum, silicon, ceramics, or glass, a first layer (2) of the original material which changes its magnetic characteristics under the influence of the various accelerated particles (3) is applied as a film by any known method, such as sputtering or vapor deposition.

The substrate (1) may be of any known design suitable for the respective purposes, for example, it may be formed as a structure with official standard layers that provide the operation of the perpendicular magnetic medium including a high-permeability layer for the magnetic circuit lines and a layer that provides the desired magnetic anisotropy of the reduced permeable first layer (2) in a direction perpendicular to this first layer (2).

Any nonmagnetic chemical compound containing atoms of at least one magnetic element and atoms of at least one element which is a gas under normal conditions, for example, an oxide, hydroxide, nitride, oxynitride, or a hydride of the magnetic material, including an oxide or a metal nitride such as iron, cobalt, nickel, or heir alloy, preferably cobalt oxide or nitride or an alloy of cobalt and platinum, may be used as the material for the first layer (2).

These materials are characterized by the absence of magnetic characteristics in the initial state and maximum magnetic properties (maximum magnetic moment) after recovery under the irradiation. This enables implementation of the selective removal of the atoms of at least one element which under normal conditions is a gas, from the initial chemical compounds under the irradiation with formation of magnetic elements and expands the range of possible use of chemical compounds.

The thickness of the first layer (2) is selected depending on the predetermined lateral dimensions of the magnetic parts of the magnetic medium that is being manufactured. For example, for manufacturing a magnetic medium with small lateral dimensions of the magnetic elements received (from 1 to 10 nm), thickness of the first layer of the original material should be 20 nm or less.

Then, the second layer (hereinafter referred to as an intermediate layer (4)) of the second material which retains its magnetic properties under the influence of various accelerated particles and has a minimal parameter of the crystal lattice, differing from the minimal parameter of the crystal lattice of the original material of the first layer (2) by 15% or less, is placed on the first layer (2) by, for example, by spattering or any other known method. The intermediate layer (4) then is formed with thickness of 3.8 nm or more, preferably 5 to 10 nm.

Then, the lithographic mask (5) that has cavities (6) according to the specified topology is placed on the intermediate layer (4). It is possible to manufacture the lithographic mask (5) in accordance with the standard procedure of lithography, for example, by e-beam lithography. The size, number, and location of the cavities (6) of the lithographic mask (5) determine the size, number, and location of the irradiated areas (7) which produce the magnetic elements.

The thickness of the intermediate layer (4) located between the original material of the first layer (2) and the lithographic mask (5) most effectively compensates for mechanical stresses and eliminates the occurrence of the magnetic properties of the original material of the first layer (2) under the lithographic mask (5) on the areas (8) located between the magnetic elements that have been obtained, including in a close proximity from the projections on the first layer (2) of the cavities (6) of the lithographic mask (5). This ensures a reduction in the lateral dimensions of each of the plurality of the magnetic elements obtained in the original material of the first layer (2) and provides an opportunity to increase the density of the magnetic elements, i.e., the number of magnetic elements per unit area of the first layer (2) while excluding the fusion of the magnetic elements that have been obtained.

Furthermore, the use of the proposed method allows to increase the magnetic moment of each of the plurality of the magnetic elements obtained in the original material of the first layer through the full recovery of the material of the first layer on the areas located under the cavities of the lithographic mask.

An incomplete compensation of the specified mechanical stresses occurs when the thickness of the intermediate layer (4) is less than 3.8 nm; whereas when the thickness of the intermediate layer (4) is greater than 10 nm, this layer (4) shields a flow of accelerated particles (3) and complicates the recovery of the original material of the first layer (2). With this, if the minimum parameter of the crystal lattice of the intermediate layer (4) material differs from the minimal parameter of the crystal lattice of the first layer (2) material by more than 15%, then the resulting mechanical stresses will initiate at least a partial yield of the atoms of an element which under normal conditions is a gas, such as oxygen, nitrogen, or hydrogen, from the original material in the areas (8) located under the lithographic mask (5) which will result in the original material having magnetic properties in the areas (8).

An oxide or nitride of a nonmagnetic material, preferably silicon nitride (Si₃N₄) is used as the material for the intermediate layer (4). The crystal lattice parameters of these materials are the most similar to the crystal lattice parameters of the preferred material of the first layer. With this, silicon nitride (Si₃N₄) is the most suitable material from the viewpoint of the lattice parameters, chemical properties, and ease of use as an intermediate layer (4). However, other known materials such as a resist or palladium nitride, chromium nitride, or combinations thereof can be used as the material of the intermediate layer (4). The sample prepared as described above is irradiated by a flow of accelerated particles (3).

Protons or hydrogen atoms, for example, can be used as accelerated particles (3). These particles (3) have a small mass, are characterized by the maximum projected range in the solid body, and allow for the selective removal of atoms of an element which under normal conditions is a gas, such as oxygen, nitrogen, or hydrogen, from the original material onto the irradiated areas (7) in which the magnetic elements are formed. It is, however, possible to use other accelerated particles (3), such as helium ions or other particles selected among the known.

The irradiation can be performed using the method described in Russian Patent No. 2129320, which is as follows. A flow of the accelerated particles is generated with certain particle energy and specific energy dispersion within the range 0.1 to 5.0 eV. The flow of the accelerated particles formed in such a way is focused through the lens system (not shown in the drawings) and directed to the lithographic mask (5). The lens system, for example, electromagnetic or electrostatic, provides the primary focus of the flow of the accelerated particles.

The flow of the accelerated particles (3) that has been formed passes through the cavities (6) in the lithographic mask (5), acquires spatial modulation in intensity, passes through the intermediate layer (4) located under the cavities (6) of the lithographic mask (5), and converts the original material capable of changing its magnetic properties under irradiation of the first layer (2) on the irradiated areas to the set of magnetic elements that exactly matches the Figureure (6) of the lithographic mask (5).

The type of particles, their dose, and energy are chosen depending on the material of the first layer (2), in which the change in the magnetic characteristics under irradiation occurs. With this, the irradiation of the first layer (2) is carried out with energy sufficient for the selective removal of atoms of an element which under normal conditions is a gas, from the material of the first layer (2). The flow parameters of the accelerated particles (3) may be selected by means of known calculation rules can be chosen experimentally.

Thus, the material of the first layer (2) is irradiated by a flow of accelerated particles (3) through cavities (6) of the lithographic mask (5). The irradiation causes a change of magnetic characteristics of the material of the first layer (2) on the irradiated areas (7) which are located opposite to the cavities (6) in the mask (5). As a result, the plurality of the magnetic elements appears on the irradiated areas (7) of the original material of the first layer (2) and unchanged magnetic characteristics of the material of the first layer in the areas (8) located between the plurality of magnetic elements, i.e., in the areas protected by the lithographic mask (5) are preserved.

The material of the first layer (2) in the areas (8), protected by the lithographic mask (5) keeps its magnetic characteristics unchanged, including areas located in a close proximity to the cavity (6) projections of the lithographic mask (5) onto this first layer (2). As a result, magnetic elements, the lateral dimensions of which correspond exactly to the lateral dimensions of the cavities (6) of the lithographic mask (5), alternating with nonmagnetic elements, are obtained, i.e., patterned magnetic structure in a nonmagnetic matrix is obtained.

A variant of the process described herein (as depicted in FIG. 1) is also possible, wherein the irradiation of the first layer (2) of the original material is performed through areas of the intermediate layer of the second material placed under the cavities (6) of the lithographic mask (5). This allows for protection of the material of the reduced magnetic element from the chemical composition changes due to environmental exposure during subsequent use.

Another variant of the process described herein (as depicted in FIG. 2) is possible, wherein the second material is removed on the areas of the intermediate layer (4) of the second material located under the cavities (6) of the lithographic mask (5) and then the first layer (2) of the original material is irradiated on the areas located immediately under the cavities (6) of the lithographic mask (5).

This allows restoring the first layer (2) material under the cavities (6) of the lithographic mask (5) with the irradiation doses several times smaller than the irradiation dose required for full recovery of the material, covered by the material of the intermediate layer (4). The radiation of the first layer (2) material by a flow of the accelerated protons or hydrogen atoms provides for a recovery of the first layer (2) material to a monatomic element with magnetic properties (metal) or a polyatomic element having magnetic properties (alloy) on the irradiated areas (7) of the first layer (2) material. With this, the first layer (2) material keeps its magnetic properties unchanged and forms parts of magnetic material in the areas (8) located between the irradiated areas (7) (even in the immediate proximity to the areas located under the cavities of the lithographic mask). This makes it possible to reduce the lateral dimensions of each of the plurality of the magnetic elements obtained in the original material of the first layer (2) to a value of 1 to 10 nm, which in its turn gives an opportunity to increase the density of the magnetic elements, that is to increase the number of magnetic elements per unit area of the first layer (2) of the original material to a value of greater than or equal to one terabyte per square inch, excluding fusion of the magnetic elements that have been obtained and increasing their magnetic moment.

After the irradiation of the lithographic mask (5) and the material of the intermediate layer (4) are removed by any known method or used as the protective layer for a magnetic medium that has been manufactured.

The claimed method allows manufacturing a magnetic medium, which comprises a patterned structure which has magnetic material areas (7) separated from one another by nonmagnetic material areas (8) and is placed on the substrate (1).

### Example 1

The described method is carried out in the following way.

A first layer of cobalt oxide (Co₃O₄) with thickness of 10 nm is applied by sputtering to the substrate (1) made of aluminum (Al) with thickness of 1 mm.

An intermediate layer of silicon nitride (Si₃N₄) with thickness of 5 nm is applied by sputtering on the surface of the first layer. Silicon nitride has a minimum lattice parameter, differing by 15% from the minimal lattice parameter of cobalt oxide (Co₃O₄). The lithographic mask (5) with cavities (6) according to the specified topology having predetermined lateral dimensions of 6×8 nm² and the distance between adjacent cavities of 10 nm is placed on the surface of silicon nitride (Si₃N₄). The lithographic mask (5) is made of silicon oxide (SiO₂) with thickness of 10 nm.

The preform prepared in such a way is secured in a holder which is placed in the processing unit chamber suitable for such purposes, for example, in a vacuum unit equipped with an ion source for irradiation.

In the chamber, the preform is irradiated with a flow of protons with energy of 0.2 keV, sufficient for selective removal of oxygen atoms from cobalt oxide (Co₃O₄) on the irradiated areas of the first layer and for obtaining the plurality of the magnetic elements in such areas.

The specified value for radiation dose sufficient to completely remove the oxygen atoms from the first layer of cobalt oxide (Co₃O₄) is determined in advance by an experiment or by calculation without using the lithographic mask (5).

As a result of the interaction between the flow of protons with cobalt oxide (Co₃O₄) in the material exactly under the cavities of the lithographic mask, the selective removal of the oxygen atoms and hence the conversion of cobalt oxide (Co₃O₄) to pure cobalt metal (Co), having magnetic properties and the formation of the magnetic elements occur. Under the areas of the first layer protected by the lithographic mask, selective removal of the oxygen atoms and hence the conversion of cobalt oxide (Co₃O₄) to pure cobalt metal (Co) or intermediate cobalt oxide (CoO) do not occur. As a result, the original material cobalt oxide (Co₃O₄) located under the mask retains its magnetic characteristics, that is, the nonmagnetic material areas are preserved in those places.

As a result of the proposed method, a magnetic medium comprising a plurality of magnetic elements, which are separated one from the other by the areas of nonmagnetic material, has been manufactured. The magnetic elements manufactures therein have a size and shape which corresponds exactly to the size and shape of the cavities the lithographic mask.

The following occurred as a result of the method discussed above.
lateral dimensions of the magnetic elements of the magnetic medium that has been manufactured decreased to 6×8 nm²,
density of the magnetic elements, i.e., the amount of the obtained magnetic elements per unit area of the first layer (2) of cobalt oxide, increased to 2.24 Tbit/inch²,
magnetic moment of each of the plurality of magnetic elements obtained by forming each magnetic element from cobalt which has maximal specific magnetic moment increased.

### Example 2

The method described below is carried out as described in Example 1.

The differences between Example 2 and Example 1 are the following.
the substrate comprises several layers: a layer of 15 nm thick permalloy, on which a layer of 2 nm thick palladium is placed,
a nonmagnetic cobalt oxide-chromium alloy (CoCr₂O₄) is used as the first layer material,
thickness of the first layer is 15 nm,
15 nm thick gamma-chrome (γ-Cr) is used as the material for the intermediate layer,
thickness of the intermediate layer is 15 nm,
the lithographic mask is made of 15 nm thick e-beam resist,
the preform is irradiated with a flow of protons with energy of 0.3 keV, sufficient for selective removal of oxygen atoms from cobalt oxide-chromium alloy (CoCr₂O₄) and obtaining magnetic cobalt-chromium alloy in the irradiated areas.
Gamma-chrome (γ-Cr) has the lattice parameter that differs from the lattice parameter of cobalt oxide-chromium alloy (CoCr₂O₄) by 4.7%.

As a result of the proposed method, a magnetic medium comprising a plurality of magnetic elements, which are separated one from the other by the areas of nonmagnetic material, has been manufactured. The magnetic elements manufactures therein have a size and shape which corresponds exactly to the size and shape of the cavities the lithographic mask.

The following occurred as a result of the method discussed above.
lateral dimensions of the magnetic elements of the magnetic medium that has been manufactured decreased to 6×8 nm²,
density of the magnetic elements, i.e., the amount of the obtained magnetic elements per unit area of the first layer (2) of cobalt oxide, increased to 2.24 Tbit/inch²,
magnetic moment of each of the plurality of magnetic elements obtained by forming each magnetic element from cobalt-chromium alloy increased.

### Example 3

The method described below is carried out as described in Example 1.

The differences between Example 3 and Example 1 are the following.
a nonmagnetic alloy oxide of cobalt and platinum (CoₓRt_{y}O) is used as the first layer material,
thickness of the first layer is 12 nm,
zirconium alloy with chromium (ZrCr₂) is used as the material for the intermediate layer,
thickness of the intermediate layer (4) is 3.8 nm,
the lithographic mask (5) is made of 9 nm thick wolfram (W),
the preform is irradiated with a flow of protons with energy of 0.4 keV, sufficient for selective removal of oxygen atoms from the first layer material and obtaining magnetic cobalt-platinum alloy in the irradiated areas.

Zirconium alloy with chromium (ZrCr₂) has a lattice parameter that differs by 11% from the lattice parameter of an alloy oxide of cobalt and platinum (CoₓPt_{y}O).

As a result of the proposed method, a magnetic medium comprising a plurality of magnetic elements, which are separated one from the other by the areas of nonmagnetic material, has been manufactured. The magnetic elements manufactures therein have a size and shape which corresponds exactly to the size and shape of the cavities the lithographic mask.

The following occurred as a result of the method discussed above.
lateral dimensions of the magnetic elements of the magnetic medium that has been manufactured decreased to 6×8 nm²,
density of the magnetic elements, i.e., the amount of the obtained magnetic elements per unit area of the first layer (2) of cobalt oxide, increased to 2.24 Tbit/inch²,
magnetic moment of each of the plurality of magnetic elements obtained by forming each magnetic element from cobalt-platinum alloy which has anisotropy of the magnetic properties whereas easy magnetic axis of each magnetic component is perpendicular to the plane of the first layer increased.

### Example 4

The method described below is carried out as described in Example 1.

The differences between Example 4 and Example 1 are the following.
cobalt nitride (CoN) is used as the first layer material,
thickness of the first layer is 10 nm,
tungsten oxide (WO₃) is used as the material for the intermediate layer,
thickness of the intermediate layer (4) is 4 nm,
the lithographic mask (5) is made of 9 nm thick wolfram (W),
the preform is irradiated with a flow of protons with energy of 0.4 keV, sufficient for selective removal of nitrogen atoms from the first layer (2) material and obtaining magnetic cobalt in the irradiated areas.

Tungsten oxide (WO₃) has a lattice parameter that differs by 11% from the lattice parameter of cobalt nitride (CoN).

As a result of the proposed method, a magnetic medium comprising a plurality of magnetic elements, which are separated one from the other by the areas of nonmagnetic material, has been manufactured. The magnetic elements manufactures therein have a size and shape which corresponds exactly to the size and shape of the cavities the lithographic mask.

The following occurred as a result of the method discussed above.
lateral dimensions of the magnetic elements of the magnetic medium that has been manufactured decreased to 6×8 nm²,
density of the magnetic elements, i.e., the amount of the obtained magnetic elements per unit area of the first layer (2) of cobalt oxide, increased to 2.24 Tbit/inch²,
magnetic moment of each of the plurality of magnetic elements obtained by forming each magnetic element from cobalt which has maximum magnetic moment increased.

### Example 5

The method described below is carried out as described in Example 1.

The differences between Example 5 and Example 1 are the following.
cobalt hydroxide Co(OH)₂ is used as the first layer material,
thickness of the first layer is 10 nm,
aluminum (Al) is used as the material for the intermediate layer,
thickness of the intermediate layer (4) is 4 nm,
the lithographic mask (5) is made of 9 nm thick wolfram (W),
the preform is irradiated with a flow of protons with energy of 0.4 keV, sufficient for selective removal of oxygen and hydrogen atoms from the first layer (2) material and obtaining magnetic cobalt (Co) in the irradiated areas.

Aluminum (Al) has a lattice parameter that differs by 15% from the lattice parameter of cobalt hydroxide Co(OH)₂.

As a result of the proposed method, a magnetic medium comprising a plurality of magnetic elements, which are separated one from the other by the areas of nonmagnetic material, has been manufactured. The magnetic elements manufactures therein have a size and shape which corresponds exactly to the size and shape of the cavities the lithographic mask.

The following occurred as a result of the method discussed above.
lateral dimensions of the magnetic elements of the magnetic medium that has been manufactured decreased to 6×8 nm²,
density of the magnetic elements, i.e., the amount of the obtained magnetic elements per unit area of the first layer (2) of cobalt oxide, increased to 2.24 Tbit/inch²,
magnetic moment of each of the plurality of magnetic elements obtained by forming each magnetic element from cobalt which has maximum magnetic moment increased.

1. A method for manufacturing a magnetic recording medium, the method comprises the steps of:
placing a first layer of an original material on a substrate wherein the first layer changes its magnetic characteristics due to various accelerated particles;
using nonmagnetic chemical compounds containing atoms of at least one magnetic element and atoms, which under normal conditions is a gas as the original material for modifying the magnetic characteristics of this original material;
placing a second layer of a second material on the first layer of the original material, wherein the second layer maintains its magnetic properties under the influence of various accelerated particles, whereby the placing of the second layer of the second material should have thickness of 3.8 nm or more;
using the material which has minimal crystal lattice parameter that differs from the minimal lattice parameter of the original material of the first layer as the second material of the second layer by 15% or less;
placing the lithographic mask which has cavities according to the specified topology on the second layer on the second material;
irradiating the first layer of the original material by a flow of the accelerated particles through the cavities of the lithographic mask in order to change the magnetic characteristics of the first layer in the original material in the irradiated areas in order to obtain the plurality of magnetic elements on the irradiated areas and to preserve magnetic characteristics of the first layer of the original material in areas protected by the lithographic mask; and
the irradiating of the first layer of the original material by a flow of accelerated particles that is carried out with energy sufficient for the selective removal of the atoms of at least one element which under normal conditions is a gas of the original material of the first layer in the irradiated areas to obtain the set of magnetic elements.

2. A method as set forth in claim 1, wherein the irradiation of the first layer of the original material is performed through areas of the second layer of the second material placed under the cavities of the lithographic mask.

3. A method as set forth in claim 1, wherein on the areas of the second layer of the second material placed under the cavities of the lithographic mask, the second material is removed and the irradiation of the first layer of the original material is carried out on its areas located directly beneath the cavities of the lithographic mask.

4. A method as set forth in claim 1, wherein the thickness of the second layer of the second material is 5 to 10 nm.

5. A method as set forth in claim 1, wherein a nitride or an oxide of magnetic material is used as the chemical compound containing atoms of at least one magnetic element and atoms of at least one element which is a gas under normal conditions.

6. A method as set forth in claim 5, wherein at least one of a metal oxide or the nitride or an alloy is used as the oxide or the nitride of the magnetic material.

7. A method as set forth in claim 6, wherein at least one of a cobalt oxide or the nitride or an alloy of cobalt and a platinum is used as the oxide or a nitride of metal or the alloy.

8. A method as set forth in claim 1, wherein the nitride or an oxide of the nonmagnetic material is used as the second material.

9. A method as set forth in claim 8, wherein a silicon nitride is used as the nitride of the nonmagnetic material.

10. A method as set forth in claim 1, wherein protons or hydrogen atoms are used as the accelerated particles.
